(19) United States
(12) Patent Application Publication
(10) Pub. No.: US 2013/0053260 A1
(43) Pub. Date: Feb. 28, 2013

(54) CHIP FOR PROTEIN DETECTION, METHOD FOR MANUFACTURING THE SAME, AND METHOD FOR DETECTING PROTEIN BY USING THE SAME

(71) Applicants: Shu-Hui CHEN, Tainan City (TW); Huang-Han Chen, Chiayi City (TW)

(72) Inventors: Shu-Hui CHEN, Tainan City (TW); Huang-Han Chen, Chiayi City (TW)

(73) Assignee: National Cheng Kung University, Tainan City (TW)

(21) Appl. No.: 13/217,538

(22) Filed: Aug. 25, 2011

(51) Int. Cl. C40B 30/04; G01N 1/31; C40B 60/12

(52) U.S. Cl. 506/9; 506/39; 427/2.13

(57) ABSTRACT

A chip for protein detection, a method for manufacturing the same, and a method for detecting protein by using the chip are provided in the present invention. The chip for protein detection of the present invention comprises: a substrate; a covalent modification layer disposed on the substrate; a fluorinated layer disposed on the covalent modification layer, wherein the fluorinated layer comprises fluorinated functional groups and bio-molecular binding groups; and antibody-binding molecules connecting to the bio-molecular binding groups.

### BACKGROUND OF THE INVENTION

1. Field of the Invention

The present invention relates to a chip for protein detection, a method for manufacturing the same, and a method for detecting protein by using the chip. More specifically, the present invention relates to a chip for protein detection with resistance against nonspecific bonding, and a method for manufacturing the same. In addition, the present invention also relates to a method for detecting protein by using the aforementioned chip for protein detection, to detect low-content target molecules.

2. Description of Related Art

Array-based technologies are excellent analytical platforms for a broad range of applications including medical testing, environmental testing, food testing, new drug development, basic research, military defense, and chemical synthesis. Various substrates, including hard materials like glass and soft materials like nitrocellulose or polydimethylsiloxane (PDMS), have been widely used for the fabrication of protein microarrays for many years.

When these substrates are applied to protein microarrays, the problems of low protein binding density, spread of the spotted material, and low signal-to-noise ratio may occur. Hence, some surface modification may be performed on the substrate to reduce these problems.

For example, the glass substrate can be coated with polar functional groups, such as polylysine, to increase the protein binding density. However, since small sample volumes (nanoliter) are applied to the hydrophilic plain glass surface, the sample may be easily evaporated. Hence, a wet environment is required during the printing process, and a high percentage of glycerol is needed in the sample buffer to keep proteins in their active wet forms. Use of microliter droplets instead of nanoliter will reduce the problem of fast solvent evaporation. However, such hydrophilic surface formed by molecules like polylysine would not allow forming microliter droplets, which will spread out on the surface. Therefore, other modification processes for the glass substrate have to be investigated, in order to apply the glass substrate to the field of protein microarrays.

In addition, a PDMS substrate is also a common substrate for protein microarrays, due to its advantages of low cost, disposability, high optical transparency, biocompatibility, and chemical stability. However, the bare PDMS substrate is hydrophobic, so high non-specific protein binding may occur when a bare PDMS substrate is applied to the field of protein microarrays. The high non-specific protein binding may greatly lower the detecting sensitivity of protein microarrays. Therefore, some modification methods, including polyelectrolyte multilayers (PEMS), silanization, radiation-induced graft polymerization, chemical vapor deposition, and phospholipid bilayer modification, are developed to make the PDMS surface hydrophilic, in order to reduce the non-specific protein binding. However, these modification methods either cannot allow forming good microdroplets without cross-contamination or effectively prevent the non-specific protein binding.

Therefore, it is desirable to provide a method for modifying the surface of the substrates, in order to provide a chip, which possesses adequate surface property for droplet formation and low non-specific binding and can be used as a protein microarray for protein detection.

### SUMMARY OF THE INVENTION

The object of the present invention is to provide a chip for protein detection with hydrophobic surface for droplet formation and also with resistance against non-specific binding.

Another object of the present invention is to provide a method for manufacturing a chip for protein detection, which is especially suitable for fabricating antibody microarrays.

A further object of the present invention is to provide a method for detecting protein, which is especially suitable for detecting target molecules in small sample volume, for example, in microliter.

To achieve the object, the chip for protein detection of the present invention comprises: a substrate; a covalent modification layer disposed on the substrate; a fluorinated layer disposed on the covalent modification layer, wherein the fluorinated layer comprises fluorinated functional groups and bio-molecular binding groups; and antibody-binding molecules connecting to the bio-molecular binding groups.

In addition, the method for manufacturing the aforementioned chip for protein detection of the present invention comprises the following steps: (A) providing a substrate; (B) forming a covalent modification layer on the substrate; (C) forming a fluorinated layer on the modification layer, wherein the fluorinated layer comprises fluorinated functional groups and bio-molecular binding groups; and (D) providing antibody-binding molecules on the fluorinated layer to connect the antibody-binding molecules to the bio-molecular binding groups of the fluorinated layer.

Furthermore, the method for detecting protein of the present invention comprises the following steps: (a) providing the aforementioned chip for protein detection; (b) coating the chip with antibodies for a target protein, wherein the antibodies connect to the antibody-binding molecules of the chip; and (c) applying a mixture to the chip coated with the antibody, wherein target proteins contained in the mixture bind to the antibodies provided on the chip. Herein, when the mixture is applied to the chip, droplets of the mixture can be formed on the surface of the chip.

According to the method for manufacturing the chip for protein detection of the present invention, the covalent modification layer is first formed on the substrate to change surface property of the substrate. Then, the fluorinated layer, which can form hydrophobic surfaces and also reduce the non-specific binding of proteins, is formed on the covalent modification layer. After the antibody-binding molecules bind to the bio-molecular binding groups of the fluorinated layer, only the antibody-binding molecules and the fluorinated functional groups are exposed. The exposed fluorinated functional groups have properties of hydrophobicity, so the problem of droplets spreading out can be prevented, even though the volume of the added droplets is in microliter. Compared to the conventional chip with a hydrophilic surface, the droplets of the added mixture have to be in nanoliter, in order to prevent the phenomenon of spreading out. However, when the mixture is added on the conventional chip, a pre-treatment on the mixture have to be performed to keep the sample in a wet form due to the easily evaporation of the nanoliter droplets. On the contrary, the chip of the present invention has a hydrophobic surface formed by the fluorinated functional group, so microliter droplets of the added mixture without any pre-treatment can be formed on the surface of the chip. In addition, according to the chip for protein detection of the present invention, the exposed fluorinated functional groups also have properties of resistance against non-specific binding, so the obtained chip for protein detection of the present invention can therefore accomplish the effect of reducing non-specific binding. When the chip for protein detection of the present invention is applied to detect target molecules, especially proteins, antibodies for target molecules are coated on the chip and connect to the antibody-binding molecule. The exposed fluorinated functional groups of the fluorinated layer can reduce the non-specific binding, so only the target proteins in the mixture may bind to the antibodies coated on the chip, even though the sample volume of the mixture is small. Hence, the sensitivity of the protein detection can further be increased. In the meantime, the fluorinated hydrophobic surface allows forming microliter droplets without spreading out which would otherwise, cause sample cross-contaminations. More specifically, the multiple droplets formed on the chip of the present invention would not spread out, and adjacent droplets would not mix with each other, even though the volume of the droplets is up to tens or hundreds microliters.

According to the chip for protein detection and the method for manufacturing the same of the present invention, the substrate may be a rigid substrate or a flexible substrate. The examples of the rigid substrate can be a glass substrate, a silicon substrate, or a quartz substrate. Preferably, the rigid substrate is a glass substrate. In addition, the examples of the flexible substrate are polymer substrate made of poly(dimethylsiloxane) (PDMS), polystyrene, polypropylene, polymethylmethacrylate, polycarbonate, or a combination thereof. Preferably, the flexible substrate is a PDMS substrate.

The method for forming the covalent modification layer on the substrate depends upon the material of the substrate. For example, when the substrate is a glass substrate, the glass substrate is first activated by oxygen plasma, and then the activated glass substrate is coated with 3-Aminopropyl triethoxysilane (APTES) to form the covalent modification layer on the glass substrate. When the substrate is a PDMS substrate, the PDMS substrate is also first activated by oxygen plasma, and then an amphiphilic layer and a cross-linked stacking layer are sequentially formed on the PDMS substrate as a covalent modification layer. The amphiphilic layer formed on the PDMS substrate has hydrophobic functional groups and reactive hydrophilic groups, wherein the hydrophobic functional groups bind to the activated PDMS substrate. Preferably, the hydrophobic functional groups are non-polar groups, and the reactive hydrophilic groups have higher polarity than the hydrophobic functional groups. Herein, not only can the oxygen plasma be used to activate the substrate, other suitable methods generally used in the art can also be used in the present invention. For example, exposing the surface of the substrate to a corona discharge solution can also activate the substrate.

The type of the cross-linked stacking layer of the present invention is not particularly limited. Preferably, the cross-linked layer has a layer-by-layer structure, wherein the cross-linked stacking layer comprises: at least one positively charged layer with positively charged functional groups, and at least one negatively charged layer with negatively charged functional groups, and the positively charged layer and the negatively charged layer stacks alternately. The topmost layer of the cross-linked stacking layer is not particularly limited, and can be the negatively charged layer or the positively charged layer. Preferably, the topmost layer of the cross-linked stacking layer is the positively charged layer. In addition, the positively charged functional groups and the negatively charged functional groups are cross-linked to each other, i.e. plural covalent bonds are formed between the positively charged functional groups and the negatively charged functional groups. Hence, plural covalent bonds are formed between the positively charged layer and the negatively charged layer. In addition, covalent bonds are also formed between the covalent modification layer and the cross-linked stacking layer. For example, when the substrate is a PDMS substrate, plural covalent bonds are formed between the reactive functional groups of the amphiphilic polymer layer and the positively/negatively charged functional groups of the cross-linked stacking layer.

In one aspect of the present invention, the material used for forming the amphiphilic polymer layer can be hydrolyzed polystyrene maleic anhydride (h-PSMA), in which the phenyl group is the hydrophobic functional group, while acid anhydride hydrolyzed to carboxylate is the reactive functional group.

In another aspect of the present invention, the material for forming the positively charged layer is polyethyleneimine (PEI), and the material for forming the negatively charged layer is polyacrylic acid (PAA). In addition, a cross-linking reagent is used to form the covalent bonds in the covalent modification layer. A suitable cross-linking reagent for the present invention can comprise, but is not limited to the commonly used EDC/NHS and H₃PO₄/K₂SO₄ buffer solution of sodium cyanoborohydride. Other cross-linking reagents with similar action are acceptable in the present invention.

According to the chip for protein detection and the method for manufacturing the same of the present invention, the chip further comprises: an intermediate layer, which is formed on the covalent modification layer. Preferably, the intermediate layer is formed on the cross-linked stacking layer. When the topmost layer of the cross-linked stacking layer is the negatively charged layer, the intermediate layer is selected to have functional groups that can react with the negatively charged functional groups. When the topmost layer of the cross-linked stacking layer is the positively charged layer, the intermediate layer is selected to have functional groups that can react with the positively charged functional groups. In one example of the present invention, the material for forming the intermediate layer may be PEG dialdehyde, PEG dicarboxylate, and PEG diamine, in which PEG dialdehyde and PEG dicarboxylate is carbonyl-containing polymer with negatively charged functional group, and PEG diamine is amino-containing polymer with positively charged functional group. Furthermore, the intermediate layer also connects with the cross-linked stacking layer and the sequential fluorinated layer through covalent bonds.

According to the chip for protein detection and the method for manufacturing the same of the present invention, the fluorinated layer is formed by applying a mixture solution on the covalent modification layer, wherein the mixture solution may contain: a fluoro-containing compound and a carboxyl-containing compound. Herein, the fluoro-containing compound has a carbon-carbon double bond and a long chain fluoro-alkyl group, wherein the carbon-carbon double bond may react with the covalent modification layer, especially the intermediate layer, and the long chain fluoro-alkyl group may be exposed to the outside and serve as the fluorinated functional group. In addition, the long chain fluoro-alkyl group can be a fluoro-C₆₋₁₅ alkyl group. Preferably, the long chain fluoro-alkyl group is a fluoro-C₈₋₁₂ alkyl group. The specific example of the fluoro-containing compound may be, but is not limited to, 1H,1H, 2H-perfluoro-1-decene (FD).

Furthermore, the carboxyl-containing compound may also contain a carbon-carbon double bond, which may react with the covalent modification layer, especially the intermediate layer. After the exposed carboxyl group of the carboxyl-containing compound is activated by the aforementioned cross-linking reagent, the antibody-binding molecules can further connect to the activated carboxyl group of the fluorinated layer. The specific example of the carboxyl-containing compound may be, but is not limited to, acrylic acid (AA).

In addition, the ratio of the fluoro-containing compound and the carboxyl-containing compound in the mixture solution depends upon the carbon number of the long chain fluoro-alkyl group. After the substrate is coated with the mixture solution, a fluorinated layer is formed on the covalent modification layer, especially the intermediate layer. The activated carboxyl groups from the carboxyl-containing compounds can serve as bio-molecular binding groups. The long chain fluoro-alkyl groups from the fluoro-containing compounds can serve as fluorinated functional groups, which can prevent the non-specific binding to the non-target molecules. The fluorinated functional groups are —(CF₂)ₘ—CF₃, and m is an integer of 6-15. Preferably, m is an integer of 8-12.

According to the chip for protein detection and the method for manufacturing the same of the present invention, the coverage of the fluorinated functional group on the covalent modification layer, especially on the intermediate layer, depends upon the ratio of the fluoro-containing compound and the carboxyl-containing compound in the mixture solution. Preferably, the coverage of the fluorinated functional group on the covalent modification layer is 20-60%.

In addition, according to the chip for protein detection and the method for manufacturing the same of the present invention, the bio-molecular binding groups are functional groups, which are capable of reacting with amino acids of the antibody-binding molecules. Preferably, the bio-molecular binding groups can react with the amino groups of the antibody-binding molecules. Herein, the antibody-binding molecules of the present invention can be any molecule which is capable of binding with antibodies. When the antibody-binding molecules bind to the bio-molecular binding groups of the fluorinated layer, covalent bonds are formed between the antibody-binding molecules and the bio-molecular binding groups. According to the chip and the method of the present invention, the antibody-binding molecules can be any molecules, which can make the Fab fragments (antigen binding fragment) of the antibodies are exposed to the outside, when antibodies are bound to the antibody-binding molecules. Preferably, the antibody-binding molecules are protein G, or avidin-biotin complex. More preferably, the antibody-binding molecules are protein G.

The method for detecting protein of the present invention may further comprise a step (d) after the step (c): analyzing the target proteins binding to the antibodies to obtain the quantity of the target proteins in the mixture. The method for analyzing the target proteins binding to the chip can be any methods generally used in the art. For example, a UV-Vis spectroscopy can be applied to the method for detecting protein of the present invention. Hence, the chip and the method for protein detection of the present invention can detect not only the presence of the target proteins, but also the quantity of the target proteins.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view showing the process for manufacturing a chip for protein detection of Embodiment 1 of the present invention;

FIG. 2 is a cross-sectional view of a chip for protein detection of Embodiment 1 of the present invention;

FIG. 3 is a perspective view showing droplets forming on a chip for protein detection of Embodiment 1 of the present invention;

FIG. 4 is a figure showing the results of static contact angles measurements on a PDMS substrate, PDMS substrates with various modifications, a chip of Embodiment 1 of the present invention, and the chip with bounded antibodies, wherein the black and white columns represent measurements on the first day and on the seventh day of storage, respectively;

FIG. 5 is a figure showing the results of ESCA measurement on a chip for protein detection of Embodiment 1 of the present invention;

FIG. 6 is a figure showing the results of ELISA for detecting the non-specific binding property of a chip for protein detection of Embodiment 1 of the present invention;

FIG. 7 is a calibration curve showing the result of the protein binding property of a chip for protein detection of Embodiment 1 of the present invention; and

FIG. 8 is a cross-sectional view of a chip for protein detection of Embodiment 2 of the present invention.

### DETAILED DESCRIPTION OF THE PREFERRED EMBODIMENT

### Materials and Chemicals

The Sylgard 184 kit, containing PDMS oligomer and curing agent, was acquired from Dow Corning (Midland, Mich.). Hydrolyzed polystyrene-alt-maleic anhydride) (h-PSMA) (MW 350 kDa), poly(ethyleneimine) (PEI) (MW 750 kDa), poly(acrylic acid) (PAA) (MW 100 kDa), 1-[3-(dimethylamino)propyl]-3-ethyl-carbodiimide hydrochloride (EDC), N-hydroxy-succinimide (NHS), tetramethylbenzidine (TMB), Tween 20, 1H,1H,2H-perfluoro-1-decene (FD), 17β-estradiol (E2), FITC-labeled BSA (FITC-BSA), sodium bicarbonate (NaHCO₃), 4-(2-Hydroxyethyl)-piperazine-1-ethanesulfonic acid (HEPES), potassium chloride (KCl), ethylenedinitrilotetraacetic acid (EDTA), ethylene glycol-bis(2-aminoethylether)-N,N,N′,N′-tetraacetic acid (EGTA), and albumin from bovine serum (BSA) were obtained from Sigma (St. Louis, Mo.). 1,4-Dithiothreitol (DTT) were obtained from J. T. Baker (Canada). Acrylate-polyethylene glycol)-N-hydroxysuccinimide (ACRL-PEG-NHS) (MW 5000) was obtained from NEKTAR (San Carlos, Calif.) and Laysan Bio (Arab, AL). The photoinitiator 2,2-Dimethoxy-2-phenylacetophenone (DPA) was obtained from Fluka (Buchs, Switzerland). Phosphate-buffered saline (PBS) was obtained from Pierce (Rockford, Ill.). Recombinant protein G was obtained from Invitrogen (Camarillo, Calif.). The rabbit anti-estrogen receptor a (anti-ERα), antimouse IgG-HRP, and mouse anti-ERα were obtained from Santa Cruz (Santa Cruz, Calif., USA). The human recombinant ERα was obtained from Invitrogen (Carlsbad, Calif.). Acrylic acid (AA) was obtained from Fluka (Buchs, St. Gallen, Switzerland). Enhanced Chemiluminescent Luminol Reagent-Kit (ECL) was obtained from PerkinElmer Life Sciences (Boston, Mass.) for detection and the emission was captured by a digital imaging system (UVP Bio-Imaging Systems, CA, USA). PBST composed of 0.05% Tween 20 in PBS buffer was prepared in house.

### Embodiment 1

### A Chip for Protein Detection with a PDMS Substrate Preparation of a Chip for Protein Detection

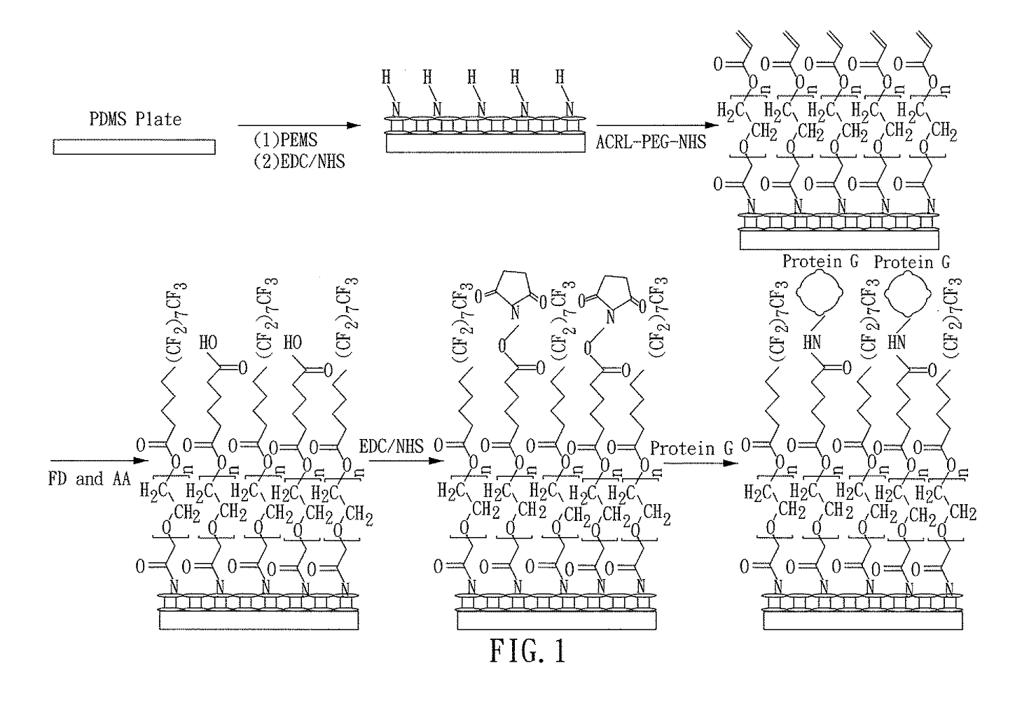

The process for forming the chip for protein detection of the present embodiment is shown in FIG. 1.

To form the PDMS prepolymer, the PDMS oligomer was mixed with a curing agent at a weight ratio of 10:1, and the resulting mixture was degassed in a vacuum for 30 min. The degassed PDMS mixture was poured on the stainless steel plate for matrix assisted laser desorption/ionization instrument (MALDI, Waters) and then cured at 70° C. for four hours. Once peeled from the stainless steel plate, the resulting 12×8 array pattern (2.5 mm id for each spot in a space of 5 cm width×4 cm length) of the PDMS substrate was used as the grid for solution printing.

The bare substrate was then modified with polyelectrolyte multilayers (PEMS). The process for modifying the bare substrate is briefly described as follow. First, the bare PDMS substrates were activated by an oxygen plasma, subsequently exposed to a solution of h-PSMA 0.25% (w/v), and then followed by sequential coatings with branched PEI (0.25% w/v in DI water) and PAA (0.5% w/v in DI water) for four repeated times with an additional PEI as the top layer (h-PSMA-(PEI-PAA)₄-PEI). In between, the PEI and FAA exposures, the substrates were washed with DI water (3×20 mL). The polyelectrolyte layers were cross-linked by the mixture containing EDC (30 mg/mL in PBS buffer) and NHS reagents (10 mg/mL in PBS buffer) to faun amide bonds between the PEI/PAA layers. Herein, the layer formed by h-PSMA was the amphiphilic polymer layer of the chip, and the layer formed by (PEI-PAA)₄-PEI was the cross-linked stacking layer of the chip. Subsequently, ACRL-PEG-NHS (1000 μg/mL in PBS, pH 7.4) was added to react with the exposed amine group of PEI molecules in the topmost layer of the cross-linked stacking layer. Therefore, an intermediate layer of the chip was obtained.

The concentration of FD for forming a fluorinated layer can be 2-30% v/v in a solvent, and the concentration of AA can be 0.5-10% v/v in the solvent. Increasing AA percentage increases the available sites for the binding of antibody-binding molecules, but decreases the surface hydrophobicity. In contrast, increasing FD percentage increases surface hydrophobicity, and can prevent the non-specific binding of non-target molecules. Hence, the percentages of FD and AA have to be optimized to reach high hydrophobicity and high number of available sites for the binding of antibody-binding molecules.

In the present embodiment, the PEMS coated surface was coated with a mixture of FD (15% v/v in ethanol), AA (1% v/v in ethanol), and DPA photoinitiator (1% w/v in ethanol), photopolymerized with under 365 nm radiation at ambient temperature for 40 min, washed with ethanol to remove extra reagents, and then dried under a nitrogen stream. The surface was then incubated with a mixture of EDC (30 mg/mL) and NHS (10 mg/mL) solution for two hours at ambient temperature. After being washed and dried, a fluorinated layer of the chip was obtained, and the AA of the fluorinated layer was activated.

Then, the activated substrate was incubated with protein G solutions with a concentration of 15-100 μg/mL. In the present embodiment, the activated substrate was incubated with a protein G solution with a concentration of 20 μg/mL at 4° C. for four hours to form covalent amide bonds between AA and the protein G, wherein the protein G serves as an antibody-binding molecule. The obtained chip was subsequently washed with PBST buffer and stored at 4° C. until use.

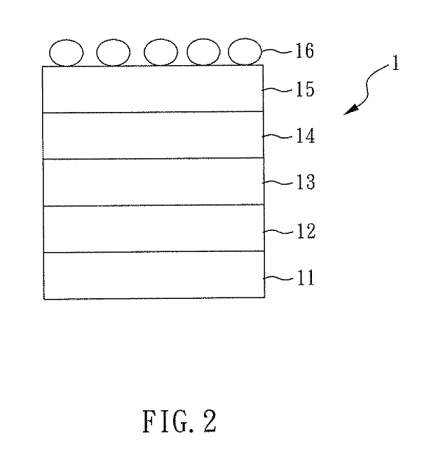

After the aforementioned process, a chip for protein detection of the present embodiment was obtained. As shown in FIG. 2, the chip 1 of the present embodiment comprises: a PDMS substrate 11; an amphiphilic layer 12 disposed on the PDMS substrate 11, wherein the amphiphilic layer 12 is formed with h-PSMA; a cross-linked stacking layer 13 disposed on the amphiphilic layer 12, wherein the cross-linked stacking layer 13 is formed with (PEI-PAA)₄-PEI; an intermediate layer 14 disposed on the cross-linked stacking layer 13, wherein the intermediate layer 14 is formed with ACRL-PEG-NHS; a fluorinated layer 15 disposed on the intermediate layer 14, wherein the fluorinated layer 15 is formed with fluorinated functional groups and bio-molecular binding groups; and antibody-binding molecules 16 connecting to the bio-molecular binding groups, wherein the antibody-binding molecules 16 are protein G.

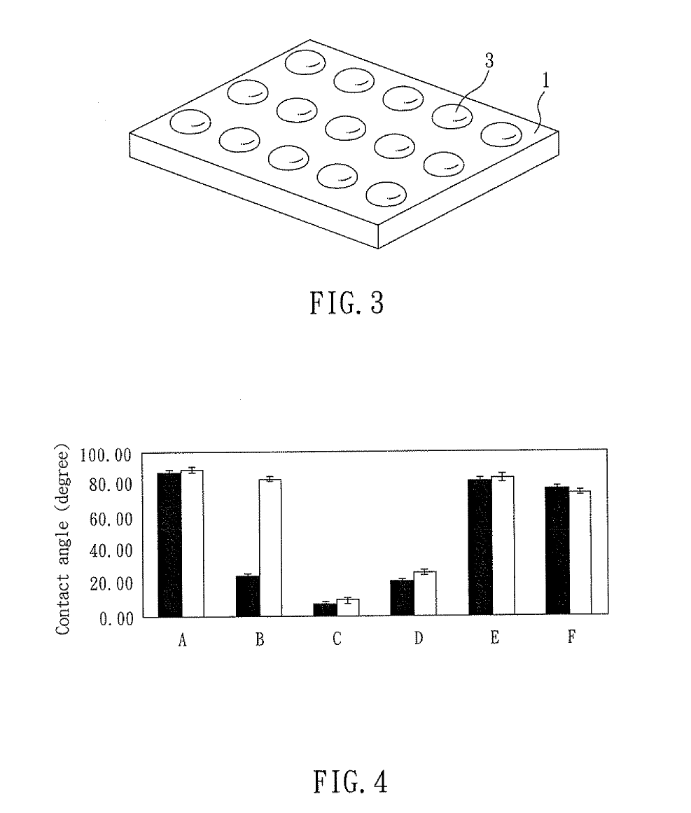

FIG. 3 is a perspective view showing droplets forming on a chip of the present embodiment. When a sample mixture is applied on the chip 1 of the present embodiment, plural droplets 3 of the sample mixture can be formed on the chip 1. In addition, the droplets 3 would not spread out and mix with the adjacent droplets 3, due to the hydrophobicity of the fluorinated layer 15 (as shown in FIG. 2). Therefore, the problem of sample cross-contaminations can be prevented.

### Measurement of the Contact Angles on the Chip for Protein Detection

The contact angle measurements were carried out using a CCD camera optical meter (Victor, Japan) with 5 μL water droplets at ambient temperature, and each measurement was repeated three times. Herein, a native PDMS substrate (plate A), an oxidized PDMS substrate (plate B), a a PDMS substrate modified with an amphiphilic layer and a cross-linked stacking layer (PEMS) (plate C), a PDMS substrate modified with an amphiphilic layer, a cross-linked stacking layer and an intermediate layer (PEMS-ACRL-PEG-NHS) (plate D), the chip of the present embodiment (plate E), the chip of the present embodiment coated with anti-ERα (plate F) were measured. All plates were dried with a stream of nitrogen before contact angle measurements. The results of the measurement of the contact angles are shown in FIG. 4.

As shown in FIG. 4, the static contact angle of a 5 μL water droplet on native PDMS (plate A) is 87.26° (standard deviation SD=2.05), which corresponds to 112° when a 10-μL droplet was used but without gravity calibration. After plasma oxidization (plate B), the static contact angle decreases to 23.21° (SD=1.78) but increases to 83.49° (SD=1.41) after 7 days of storage. PEMS modification (plate C) results in a hydrophilic surface with a contact angle of 6.55° (SD=1.13). This contact angle is slightly increased to 8.71° (SD=1.43) after 7 days of storage. PEG modification (PEMS-ACRL-PEG-NHS) (plate D) increases the contact angle to 20.23° (SD=1.15) and exhibits a long-term hydrophilicity. Upon coating with FD/AA (i.e. the chip of the present embodiment, plate E), the contact angle of 81.97° (SD=1.55). After antibody anti-ERα antibody coated on the chip of the present embodiment (plate F), the surface of the chip remains hydrophobic and the contact angle of the plate F is 76.90° (SD=1.72). Moreover, the contact angles of the plate E and plate F do not change significantly after 7 days of storage. These results indicate that the fluorinated layer of the chip of the present embodiment is stable and hydrophobic as bare PDMS.

### Characterization of the Chemical Composition of the Chip for Protein Detection

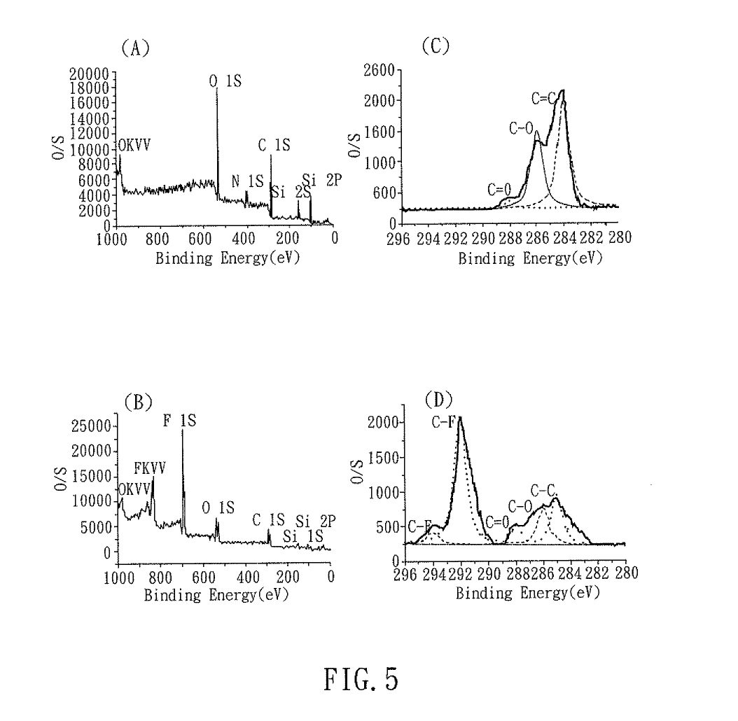

ESCA (Electron Spectroscopy for Chemical Analysis) measurements were used to characterize the chemical composition of each layer of the chip of the present embodiment. ESCA measurements were carried out on an ULVAC-PHI 5000 VersaProbe (PHI, Tokyo, Japan) in Al KR mode. Before the measurements, the chip was washed with PBS buffer and then dried with a stream of nitrogen. The results of the ESCA measurements are shown in FIG. 5.

FIG. 5(A) shows the results of ESCA measurements on the intermediate layer (ACRL-PEG-NHS) on the top of a PEMS-coated PDMS substrate, and FIG. 5(C) is a Gaussian multipeak fit from the C 1s spectrum of the FIG. 5(A). As shown in FIG. 5(A), the spectral lines of C 1s (284 eV), N 1s (400.5 eV), O 1s (532.5 eV), Si 2s (153.5 eV), and Si 2p (102.5 eV) are clearly evident from the PEMS-PEG coated surface that was cross-linked with amide bonds. A Gaussian multipeak fit reveals that the chemical states of C 1s are C—H, C—C, C═C, and C—O/C—O with respective energies at 284, 286, and 288 eV (FIG. 5(C)).

FIG. 5(B) is the results of ESCA measurements on the fluorinated layer (ACRL-PEG-NHS) on the top of an ACRL-PEG-NHS-coated PDMS substrate, and FIG. 5(D) is a Gaussian multipeak fit from the C 1s spectrum of the FIG. 5(B). As shown in FIG. 5(B), a strong band of F 1s (690.8 eV) is observed, but other atomic (C, N, O, and Si) lines are decreased. The Gaussian multipeak fit further reveals that the chemical states of C 1s are C—F groups with two energies at 292 and 294 eV, as shown in FIG. 5(D). These results show that the fluorinated layer is indeed formed on the PDMS substrate. Moreover, the percentage of F was estimated to be around 35.4%.

### Non-Specific Binding Test

To compare the resistance against nonspecific binding, a PDMS substrate modified with an amphiphilic layer and a cross-linked stacking layer (named as a first comparative chip, hereafter), a PDMS substrate modified with an amphiphilic layer, a cross-linked stacking layer and an intermediate layer (named as a second comparative chip, hereafter), and a PDMS substrate modified with an amphiphilic layer, a cross-linked stacking layer, an intermediate layer and a fluorinated layer (i.e. the chip of the present embodiment) were investigated.

Antimouse IgG-HRP solution (0.4 μg/mL) and TMB solution were sequentially added into each chip. After two hours of incubation and PBS wash, an ELISA reader (TECAN, Austria) equipped with a photomultiplier tube (PMT) was used to capture the emission from each chip, and the measured intensities were digitized by Image J software, version 1.41. (http://rsb.info.nih.gov/ij/download.html). FITC-labeled BSA solution (100 μg/mL) incubated 2 h was also applied to the surface to investigate nonspecific binding following the same wash procedure used for the antimouse IgG-HRP solution. Fluorescence imaging (Ex=480 nm, Em=570 nm) was also captured by UVP, Bio-Imaging Systems (CA), which has a detection limit of 2 μg/mL for FITC-labeled BSA solution.

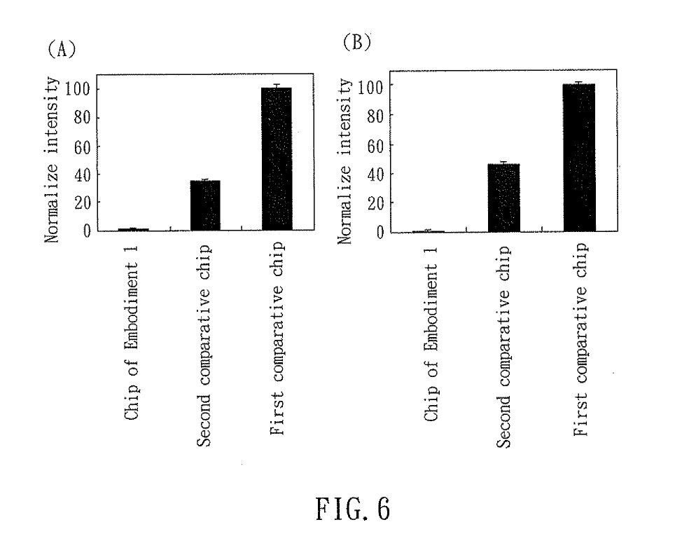

FIG. 6(A) is the results showing the binding of antimouse IgG-HRP on the chip of the present embodiment, the first comparative chip, and the second comparative chip; and FIG. 6(B) is the results showing the binding of FITC-labeled BSA on the chip of the present embodiment, the first comparative chip, and the second comparative chip. As shown in FIG. 6, the chip of the present embodiment exhibited extremely low background emission. Compared to the second comparative chip, the reduction in non-specific binding by the fluorinated layer on the chip of the present embodiment was estimated to be more than 1 order of magnitude.

Hydrophobic or ionic (acidic silanol groups) interactions are the major causes of non-specific binding on native PDMS substrates. BSA protein is commonly used as a blocking reagent to reduce nonspecific binding in ELISA assays. Poly(ethylene glycol) (PEG) is also a common reagent used in various biochemical analyses to reduce nonspecific binding. Basically, because these chemicals are ionic or hydrophilic, they resist non-specific binding through electrostatic or steric hindrance effects. The aforementioned results indicate that the fluorinated compounds of the fluorinated layer are better blocking reagents than BSA and nonfat milk and, therefore, exhibited a stronger resistance to non-specific binding. Hence, the fluorinated layer of the chip of the present embodiment can create a surface that is hydrophobic but could resist non-specific binding.

### Protein Binding Efficiency Test

The human breast cancer cell line, MCF-7, was grown at 37° C. in a humidified 5% CO₂ atmosphere in Dulbecco's Modified Eagle's Medium (DMEM) supplemented with fetal bovine serum (10%) and NaHCO₃. Penicillin (1%) and antibioticantimycotic (1%) were added to the medium to inhibit bacterial growth. The cell growth was monitored daily using a microscope until the cells reached a state of confluence of 80-90%. Cells were then lysed with lysate buffer A (HEPES 10 mM, KCl 10 mM, EDTA 0.5 mM, EGTA 0.5 mM, and DTT 1 mM) and buffer B (HEPES 20 mM, KCl 10 mM, EDTA 1 mM, EGTA 1 mM, and DTT 1 mM). The cell lysate was used immediately or kept frozen at −80° C. until use.

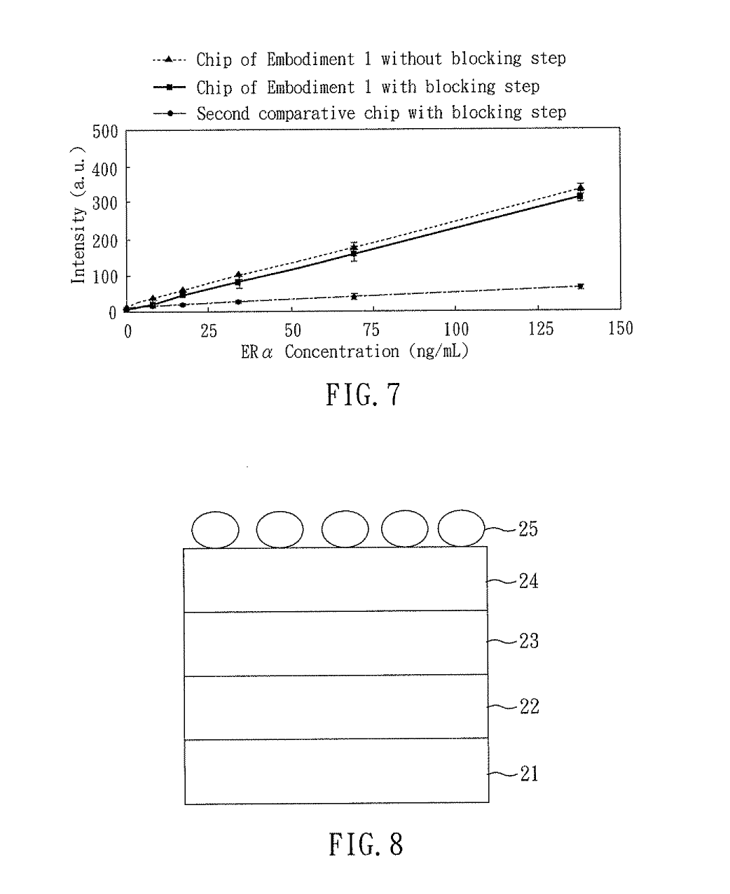

The chip of the present embodiment coated with protein G (binding density of protein G=0.24 μg/mm²), and the second comparative chip coated with protein G (binding density of protein G=0.29 μg/mm²) were immersed in the antibody solution (rabbit anti-ERα, 1 μg/mL in PBST buffer) for two hours and then washed with PBST to remove unbound species. For microarray printing, each standard recombinant ERα solution (at concentrations of 138, 69, 34, 17, 8, and 0 ng/mL in PBST buffer) and the MCF-7 cell lysate solution were pipetted (4 μL) onto the chips with transferred MALDI grids. Sandwich assays were used for antibody microarray detection. After two hours of incubation, mouse anti-ERα (0.4 μg/mL in PBST buffer) and antimouse IgG-HRP (0.4 μg/mL in PBST buffer) were sequentially added. Finally, ECL reagent was added and the chip was covered with pre-cleaned glass to enable detection of the emitted chemiluminescence signals by a BioSpectrum imaging system (UVP, Bio-Imaging Systems, CA), same system as that used for fluorescence measurement. The result is shown in FIG. 7.

As shown in FIG. 7, the detection limit of the chip of the present embodiment was estimated to be around 8 ng/mL for ERα solution, which is much lower than a commercial ELISA kit for ERα (>12 μg/mL) as specified by the manufacturer. In addition, FIG. 7 also shows that the effect of the chip of the present embodiment without using a blocking reagent is comparable to that using the blocking reagent. This indicates that the blocking step can be eliminated when using the chip with the fluorinated layer, thereby reducing the processing time and labor and leading to a simplified bioassay.

In addition, the fitted linear calibration equation of the chip of the present embodiment using the blocking reagent is Y=0.0090X+0.0777 (R²=0.9986), and that of the chip of the present embodiment without using the blocking reagent is Y=0.0091X+0.0194 (R²=0.9982). The fitted linear calibration equation of the second comparative chip is Y=0.0015X+0.0663 (R²=0.9903). The aforementioned fitted linear calibration equations indicate that the chip of the present embodiment is 6 times more sensitive than the second comparative chip. It illustrates that the fluorinated layer of the chip of the present embodiment exhibits lower non-specific binding and thus higher specific binding than the PEG layer (i.e. the intermediate layer) of the second comparative chip.

In addition, the chip of the present embodiment also shows long-term reactivity after 7 days storage in dried and cold (4° C.) conditions.

On the basis of the constructed calibration curve, the concentration of ERα in MCF7 cells was determined to be 48±2.2 ng/mL, which is consistent with results reported in the literature. A standard addition method was also used to validate the detected amount of ERα in MCF-7 cells by spiking standard ERα solution into the MCF-7 cell lysate (the final spiking concentration was 34 ng/mL). The spiked solution was analyzed by the chip of the present embodiment coated with anti-ERα antibody and the concentration of the spiked solution was determined to be 84.6 (±0.3) ng/mL based on the calibration curve constructed in FIG. 7. The concentration in the nonspiked MCF-7 cells was determined by subtraction to be 50.6 (±0.3) ng/mL, which agrees with the value obtained without spiking (48±2.2 ng/mL). Alternatively, the spiked amount can be calculated as 36 ng/mL if the amount of ERα in the nonspiked solution (48±2.2 ng/mL) is subtracted from the detected concentration. These concentration determinations demonstrate the excellent recovery rate (101±0.0036) % of the chip of the present embodiment. Hence, even though an easy cleanup is performed on the chip of the present embodiment, the object of low contamination on the chip still can be achieved.

### Embodiment 2

### A Chip for Protein Detection with a Glass Substrate Preparation of a Chip for Protein Detection

The process for forming the chip for protein detection of the present embodiment is similar to that of Embodiment 1, except that PDMS substrate is substituted with a glass substrate.

First, the bare glass substrate was activated by an oxygen plasma, and subsequently coated with 3-Aminopropyl triethoxysilane (APTES) to form a covalent modification layer on the surface of the glass substrate. Then, ACRL-PEG-NHS (1000 μg/mL in PBS, pH 7.4) was added to react with the exposed amine group of APTES molecules in the covalent modification layer. Therefore, an intermediate layer was formed on the glass substrate.

The same process for forming the fluorinated layer described in Embodiment 1 was performed in the present embodiment to form a fluorinated layer on the glass substrate. Then, the same process for coating the protein G described in Embodiment 1 was also performed in the present embodiment to connect protein G to the fluorinated layer, wherein protein G was served as an antibody-binding molecule.

After the aforementioned process, a chip for protein detection of the present embodiment was obtained. As shown in FIG. 8, the chip of the present embodiment comprises: a glass substrate 21; a covalent modification layer 22 disposed on the glass substrate 21, wherein the covalent modification layer is formed with APTES; an intermediate layer 23 disposed on the covalent modification layer 22, wherein the intermediate layer 23 is formed with ACRL-PEG-NHS; a fluorinated layer 24 disposed on the intermediate layer 23, wherein the fluorinated layer 24 is formed with fluorinated functional groups and bio-molecular binding groups; and antibody-binding molecules 25 connecting to the bio-molecular binding groups, wherein the antibody-binding molecules 25 is protein G.

Although the present invention has been explained in relation to its preferred embodiment, it is to be understood that many other possible modifications and variations can be made without departing from the spirit and scope of the invention as hereinafter claimed.

What is claimed is:

1. A chip for protein detection, comprising:
a substrate;
a covalent modification layer disposed on the substrate;
a fluorinated layer disposed on the covalent modification layer, wherein the fluorinated layer comprises fluorinated functional groups and bio-molecular binding groups; and
antibody-binding molecules connecting to the bio-molecular binding groups.

2. The chip as claimed in claim 1, wherein the substrate is a rigid substrate, or a flexible substrate.

3. The chip as claimed in claim 1, wherein the antibody-binding molecules are protein G, or avidin-biotin complex.

4. The chip as claimed in claim 1, wherein the fluorinated functional groups are —(CF₂)ₘ—CF₃, and m is an integer of 6-15.

5. The chip as claimed in claim 1, wherein the bio-molecular binding groups are functional groups, which are capable of reacting with amino acids of the antibody-binding molecules.

6. The chip as claimed in claim 1, wherein the coverage of the fluorinated functional group on the covalent modification layer is 20-60%.

7. A method for manufacturing a chip for protein detection, comprising the following steps:
(A) providing a substrate;
(B) forming a covalent modification layer on the substrate;
(C) forming a fluorinated layer on the covalent modification layer, wherein the fluorinated layer comprises fluorinated functional groups and bio-molecular binding groups; and
(D) providing antibody-binding molecules on the fluorinated layer to connect the antibody-binding molecules to the bio-molecular binding groups of the fluorinated layer.

8. The method as claimed in claim 7, wherein the substrate is a rigid substrate, or a flexible substrate.

9. The method as claimed in claim 7, wherein the antibody-binding molecules are protein G, or avidin-biotin complex.

10. The method as claimed in claim 7, wherein the fluorinated functional groups are —(CF₂)ₘ—CF₃, and m is an integer of 6-15.

11. The method as claimed in claim 7, wherein the bio-molecular binding groups are functional groups, which are capable of reacting with amino acids of the antibody-binding molecules.

12. The method as claimed in claim 7, wherein the coverage of the fluorinated functional group on the covalent modification layer is 20-60%.

13. A method for detecting protein, comprising the following steps:
(a) providing a chip for protein detection, wherein the chip comprises: a substrate; a covalent modification layer disposed on the substrate; a fluorinated layer disposed on the covalent modification layer, wherein the fluorinated layer comprises fluorinated functional groups and bio-molecular binding groups; and antibody-binding molecules connecting to the bio-molecular binding groups;
(b) coating the chip with antibodies for a target protein, wherein the antibodies connect to the antibody-binding molecules of the chip; and
(c) applying a mixture to the chip coated with the antibody, wherein target proteins contained in the mixture bind to the antibodies provided on the chip.

14. The method as claimed in claim 13, further comprising a step (d) after the step (c): analyzing the target proteins binding to the antibodies to obtain the quantity of the target proteins in the mixture.

15. The method as claimed in claim 13, wherein the substrate is a rigid substrate, or a flexible substrate.

16. The method as claimed in claim 13, wherein the antibody-binding molecules are protein G, or avidin-biotin complex.

17. The method as claimed in claim 13, wherein the fluorinated functional groups are —(CF₂)ₘ—CF₃, and m is an integer of 6-15.

18. The method as claimed in claim 13, wherein the bio-molecular binding groups are functional groups, which are capable of reacting with amino acids of the antibody-binding molecules.

19. The method as claimed in claim 13, wherein the coverage of the fluorinated functional group on the covalent modification layer is 20-60%.
